(19) United States
(12) Patent Application Publication
(10) Pub. No.: US 2004/0200993 A1
(43) Pub. Date: Oct. 14, 2004

(54) Reactive liquid polymer crosslinking agent and process for preparation

(76) Inventors: Warren G. Lazar, Oro Valley, AZ (US); James A. Clark, Tucson, AZ (US)

Correspondence Address: Anthony G. Eggink, Eggink & Eggink, 3100 First National Bank Building, 332 Minnesota Street, St. Paul, MN, 55101, US

(21) Appl. No.: 10/833,816

(22) Filed: Apr. 27, 2004

Related U.S. Application Data
(63) Continuation-in-part of application No. 10/013,164, filed on Dec. 10, 2001, now abandoned.

(51) Int. Cl. C09K 3/00

(52) U.S. Cl. 252/182.13

(57) ABSTRACT

A reactive liquid crosslinking agent for use in the preparation of polymeric substances. The crosslinking agent comprises a substituted 1,3,5-triazine reacted with water, an acid alkyl sulfonate and/or phosphonate and a solidifying modifier containing an hydroxyl functional group to form a substituted 1,3,5-triazine hydrate. The reactive liquid polymer crosslinking agent has a solids content between 20-99% solids. The reactive liquid crosslinking agents (RLPC's) are useful as modifiers in the preparation of polymeric compounds which are suitable for one-component self-crosslinking adhesives, coatings and polymers used in optics, textiles, composites, casting and molding. RLPC systems containing from 1-30% RLPC provide fast single package thermosetting polymeric compounds with enhanced properties such as chemical, heat and abrasion resistance.

### BACKGROUND OF THE INVENTION

This application is a continuation-in-part of Applicant's co-pending U.S. application Ser. No. 10/013,164, filed Dec. 10, 2001.

This invention relates generally to a crosslinking agent. Particularly, this invention relates to a reactive liquid polymer crosslinking agent for use as a crosslinker for enhancing properties of polymer systems. More particularly, this invention relates to a crosslinking agent which is a substituted amino 1,3,5-triazine hydrate. Further, the invention relates to processes for the preparation and use of the reactive liquid polymer crosslinking agent.

The reactive liquid polymer crosslinking agent (RLPC) of the present invention may be used in the preparation of a variety of polymer compounds and materials and to provide a range of desirable properties. For example, the polymer cross-linking agents of the invention may be used in thermoplastic resins to increase stability at higher temperatures. The use of RLPC with epoxies, for example, produces epoxies having increased flexibility and higher impact and heat resistance than present epoxy resins. With respect to hot-melt adhesives, for example, increased toughness at usable viscosities can be produced using the RLPC of the present invention. The RLPC of the present invention has also been found to improve the chemical resistance and thermal stability of polyesters, the chemical resistance and weatherability of acrylic resins, and the solvent resistance and thermal stability of many alternative coatings. The use of the RLPC of the present invention in the preparation of urethane foams improves resistance to tear, abrasion, creep and flexural stress.

Polymers can be linear or crosslinked. Thermoplastics are polymers which soften when heated and harden when cooled. Molding does not change their chemical structure. Most thermoplastics are rigid, but some are highly elastic (thermoplastic elastomers, or TPE's), and can be stretched repeatedly to at least twice their original length at room temperature, then return to near their original length. Linear polymers have a single backbone chain of atoms which vibrate greatly when the polymer is heated. Cross-linked polymers do not have a single backbone chain of atoms, instead a cross-linked chain of atoms is interconnected. Thus, a linear polymer will become molten easier than a cross-linked polymer. A highly cross-linked molecule will have more frequent points of connection among the chains and will not melt because each atom is restrained from random motion by its connections to other atoms in the structure. The number of crosslinks per unit volume influences all solubility, thermal stability, and mechanical strength. Highly cross-linked molecules are insoluble because solvents are unable to penetrate the complex cross-linked structures. Creative techniques in the use of thermoplastics continue to emerge at a rapid pace.

A thermoplastic's properties depend on its chemistry, structure, chain length, and the bonds between chains. A plastic's physical and mechanical properties can be modified with additives, fillers, reinforcements, and chain extenders. Thermoplastics are used in clothing, housing, automobiles, aircraft, packaging, electronics, signs, recreation items, and medical implants, for example.

An object of the present invention is to provide an innovative method to chain extending thermoplastic resins that can be designed with unique physical, chemical, and environmental properties.

An example of a thermoplastic material is polyurethane. Polyurethanes are commonly used in many industries due to the diversity of the physical properties that are obtainable. For example, polyurethanes can be used in construction materials, pillow fillers, flexible foams for sealing, cushions and mattresses, integral skin foams for automobile steering wheels, dash boards, auto interiors, semi-rigid foams for industrial and door panels, energy absorbing foams, automotive and construction adhesives and sealants, RIM panels and sound dampening applications, theme park and three dimensional advertising murals, sports surfaces, and approach roads. However, polyurethanes typically have poor heat and solvent permanence and are relatively slow to cure. The use of the reactive liquid crosslinking agents (RLPC) of the present invention with polyurethanes makes them more desirable.

The use of RLPC polyurethanes as coatings in industrial maintenance, for example, have been known to yield durable, abrasion-, chemical- and UV-resistant, and hard but flexible coatings. These coatings can be used in many applications, for example, under-the-soil, overland and undersea pipelines, waste water & sewage treatment plants, primary and secondary containments, overhead water tanks, in the interior and on the exterior of water supply pipelines, for penstock pipes in hydroelectric generation plants, road and railway bridge maintenance, port establishments, sports stadium floors, steps and benches, floodlight pillions, indoor and outdoor recreational surfaces, television transmission and communication towers, and railway track electrical structures. Polyurethane coatings can also be used as exterior coating on chemical, petroleum storage tanks reducing vapor pressure inside the tank and thereby significantly lowering the evaporation rate of the contents. Similar coatings can also be used on the exteriors of cold rooms and cold storage facilities, refrigerated containers, air-control ducting, railway, and road tankers and on the exterior of structures for thermal insulation.

The prior art, so far as is known, does not teach the chemical composition and processes of the present invention. The related art, for example, discloses additives to polymeric compositions, synthetic resins and concrete, for example, which form solid reaction products or have no reactivity towards polymers or polymer resins. Other related art discloses flame retardants and crosslinkers or bonders which require the use of strong acids and high temperatures to cure them. Therefore, there is a need for a crosslinking agent which is liquid, reactive and which can be reacted at nearly ambient temperature and pressure without the use of strong catalysts and for short reaction times.

It is, therefore, an object of the present invention to provide a self-reactive polymer cross linking agent for thermoplastic resins, capable of crosslinking or chain extending at relatively low temperatures. Another object of the invention is to provide a liquid reactive polymer crosslinker or chain extender for a wide range of thermoplastic resins to provide innovative properties.

### SUMMARY OF THE INVENTION

This invention relates to a reactive liquid polymer crosslinking agent comprising a 1,3,5-triazine modified with acid alkyl phosphates and/or acid alkyl sulfonates, water and a solidifying modifier to form a substituted 1,3,5-triazine hydrate. The invention further relates to processes for the preparation of the crosslinking agent as well as uses of the crosslinking agent in polymer systems.

The invention discloses a modified stable liquid 1,3,5-triazine hydrate or a substituted 1,3,5-triazine hydrate, which does not depend on acid or basic catalysts to promote chain extending or crosslinking of polymeric resins. The crosslinking agents provided cure rapidly at room temperature. Further, combinations of RLPC polyester resin and polyurethane, for example, are provided which permit a wide variety of coating formulations to force dry or cure at room temperature. These coatings are useful on wood, paper, and metals and may be clear or pigmented.

The RLPCs are prepared by providing a situation for hydrogen bonding to take place between the H—N—H groups of 1,3,5-triazine and sulfo and/or phospho groups in the presence of water and a hydroxyl functional group. Thus, a substituted triazine hydrate is formed by reaction between 1,3,5-triazine, water, the sulfo and/or phospho groups and a solidifying modifier having a hydroxyl functional group.

Numerous benefits are associated with the use of RLPC-cured coating systems. For example, expensive pollution control equipment is not needed when using RPLCs because VOC and HAP emissions are virtually eliminated. Further, the fire and explosion hazard associated with solvent borne coatings is eliminated, significantly decreasing hazard insurance premiums and eliminating the need for LEL monitoring and explosion-proof equipment. Full curing of the coating occurs within minutes of exposure to dry air or elevated temperature, enabling fast production rates. RLPC-cured coatings can be compatible with both solvent borne or waterborne coatings, therefore, a facility does not have to convert an entire production to a new-curing system. RLPC-cured adhesives have higher chemical resistance and higher shear strength at elevated temperatures as compared to hot-melt adhesives, making them potentially feasible for high-performance applications. RLPC-cured coatings are provided which can typically be applied with existing application equipment. Frequent equipment cleaning is not necessary when using RLPCs because, they are in a liquid state and remain fluid until exposed to dry air or elevated temperatures.

These and other benefits of this invention will become clear from the following description by reference to the drawing.

### BRIEF DESCRIPTION OF THE DRAWING

FIG. 1 is a flow chart showing the process of preparation of preparing the RLPC of the present invention.

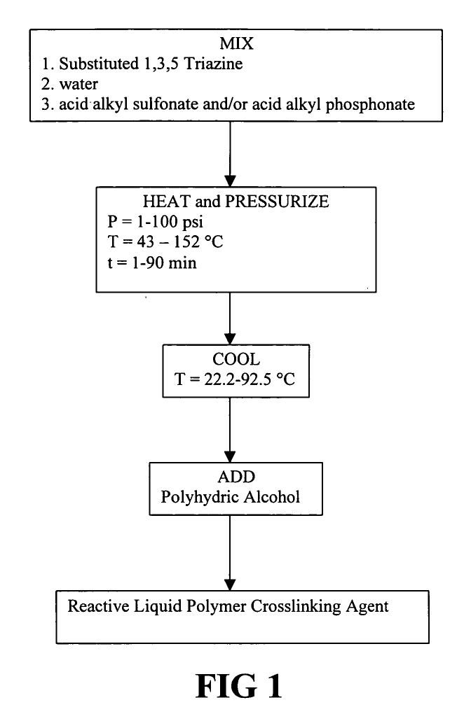

### DESCRIPTION OF THE PREFERRED EMBODIMENTS

This invention relates to a Reactive Liquid Polymer Crosslinking Agent (RLPC), which is a substituted 1,3,5-triazine hydrate, having a solids content of at least 20% to 99% by weight, at a viscosity of 20 to 12,500 centipoise on the Brookfield® scale. RLPC systems containing from 1-30% RLPC provide fast single package thermosetting polymeric compounds which provide chemical, heat and abrasion resistance. The present invention used as a single package thermosetting liquid resin is useful to modify polymeric materials containing carboxyl, hydroxyl, lactone or amide groups such as certain types of acrylic, urethane, polycaprolactone, alkyds vinyl polymers, for example PVA and PVB. The RLPC's are also useful as modifiers in the preparation of polymeric compounds which are suitable for one-component self-crosslinking adhesives, coatings and polymers used in optics, textiles, composites, casting and molding.

The process for the preparation of RLPC product comprises heating a starting material of butylated 1,3,5-triazine or related species in the presence of water, to facilitate the hydration of the 1,3,5-triazine, and an acid alkyl sulfonate and/or an acid alkyl phosphonate, under effective reaction conditions and further adding a solidifying modifier having a polyhydroxyl functional group. These processes form a substituted amino 1,3,5-triazine hydrate.

The reaction, hydration, is carried out under atmospheric pressure (generally 1.00 to 100 psi) and at a pH of 2.3-8.7. In the case where an acid alkyl sulfonate is reacted, the mixture is heated to 43-132° C. for 1 to 56 minutes. In the case where an acid alkyl phosphonate is reacted, the mixture is heated to 60-1 52° C. for 12 to 90 minutes. The molar ratio of free water to the sum of free and converted 1,3,5 triazine should preferably not fall below 1% for the duration of the reaction.

Modifications of the basic process involve carrying out the hydration/sulfonation and/or phosphation of the 1,3,5-triazine and further cooling the product between 22.2-92.5° C. The product may then be placed into a centrifuge for 1-30 minutes, or until any unreacted 1,3,5-triazine has separated out. The unreacted 1,3,5-triazine may then be washed and recycled. The aqueous solution remaining is the purified RLPC, which is then mixed with a solidifying modifier having a polyhydroxyl functional group to form the RLPC of the present invention.

Particularly suitable substituted 1,3,5-triazines for use in the present invention are the following compounds: 2-n-methoxyamino-4,6-diamino-1,3,5-triazine; 2-di(methoxyamino)-4,6-diamino-1,3,5-triazine; 2,4-di(methoxyamino)-,6-amino-1,3,5-triazine; 2-n-butylmethoxyamino-4,6-diamino-1,3,5-triazine; 2-di(butylmethoxyamino)-4,6-diamino-1,3,5-triazine; 2,4-di(butylmethoxyamino)-6-amino-1,3,5-triazine; 2-n-butylamino-4,6-diamino-1,3,5-triazine; 2-di(butylamino)-4,6-diamino-1,3,5-triazine; 2,4-di(butylamino)-6-amino-1,3,5-triazine; 2-n-ethylmethoxyamino-4,6-diamino-1,3,5-triazine; 2,6-di(ethylmethoxyamino)-4-diamino-1,3,5-triazine; 2,6-di(butylmethoxyamino)-4-diamino-1,3,5-triazine; 2-di(2-hydroxyethylamino-4,6-diamino-1,3,5-triazines; 4-hydroxyethylamino-2,6-diamino-1,3,5-triazine; 2,4-di(2-hydroxyethylamino)-6-amino-1,3,5-triazine, 2,4-tris(2-hydroxyethylamino)-6-amino-1,3,5-triazine; 2-hydroxyisopropylamino-4,6-diamino-1,3,5-triazine; 1,3,5-triazine, 2,4-di(2-hydroxyisopropylamino)-6-amino-1,3,5-triazine; 2-isopropylmethoxyamino-4,6-diamino-1,3,5-triazine; 2,4-di(methoxyamino)-6-amino-1,3,5-triazine; 4,6-di(ethylmethoxyamino)-2-amino-1,3,5-triazine; 4,6-di(butylmethoxyamino)-2-amino-1,3,5-triazine; 2,-di(methoxyamino)-4,6-diamino-1,3,5-triazine; 2-ethylamino-4,6-diamino-1,3,5-triazine;2,4-bis(ethylamino)-6-amino-1,3,5-triazine; 2,4,6-tris(ethylamino)-1,3,5-triazine; 2-diethylamino-4,6-bis(ethylamino)-1,3,5-triazine 8.2; 2-melamino-4-ethylamino-6-amino-1,3,5-triazine; 2-benzylamino-4,6-diamino-1,3,5-triazine; 2,4-bis(benzylamino)-6-amino-1,3,5-triazine; 2,4,6-tris(benzylamino)-1,3,5-triazine; 2-dibenzylamino-4,6-bis(benzylamino)-1,3,5-triazine; 2-n-butylamino-4,6-diamino-1,3,5-triazine; 2,4-bis(n-butylamino)-6-amino-1,3,5-triazine; 2,4,6-tris(n-butylamino)-1,3,5-triazine; 2-di-n-butylamino-4,6-bis(n-butylamino)-1,3,5-triazine; 2,4-bis(di-n-butylamino)-6-n-butylamino-1,3,5-triazine; 2-benzylamino-4,6-diamino-1,3,5-triazine; 2,4-bis(benzylamino)-6-amino-1,3,5-triazine; 2,4,6-tris(benzylamino)-1,3,5-triazine; 2-n-butylamino-4,6-diamino-1,3,5-triazine; 2,4-bis(n-butylamino)-6-amino-1,3,5-triazine.

Particularly suitable substituted acid alkyl sulfonates and phosphonates include: 2-acrylamido-2-methylpropane-sulfonic acid; neopentyl(diallyl)oxy,tri(dodecyl)benzene-sulfonyltitanate; polyoxyalkylated alkyl phosphate ester; polyoxyalkylated alkyl sulfate ester; neopentyl(diallyl)oxy,tri(dioctyl)pyro-phosphatotitanate; phenylsulfonic acid/esters; neopentyl(diallyl)oxy,tri(dodecyl)benzene-sulfonylzirconate; phenylphosporic acid/esters; neopentyl(dially)oxy,tri(dioctyl)pyro-phosphatozirconate; 4-(phenylsulfonyl)-2-azetidinone; 2-(phenylsulfonyl)acetonitrile; 2-(phenylsulfonyl)ethanol; 1-(phenylsulfonyl)pyrrole; di(dioctyl)pyrophosphate,oxoethylenetitanate; 2-(phenylsulfonyl)tetrahydropyran; di(butyl,methyl)pyrophosphato,oxoethylene di(dioctyl)phosphitotitanate; ,4-sulfonylidiphenol; di(dioctyl)pyrophosphatoethylenetitanate; di(butyl,methyl)pyrophosphato,ethylenetitanate; isopropyl tri(dodecyl)benzenesulfonyl titanate; isopropyl(4-amino)benzenesulfonyl di(dodecyl)benzenesulfonyl titanate; isopropyl tri(dioctyl)pyrophosphatotitanate, dimethyl sulfate, diethyl sulfate, dipropyl sulfate, dimethyl phosphate, tin methanesulfonate, titanium methanesulfonate, tin ethanesulfonate.

Suitable solidifying modifiers have hydroxyl functional groups, however, the preferred polyols have molecular weights of from 200 to 4,500 and hydroxyl numbers of from 24 to 800. They include: ethylene glycol, diethylene glycol, 1,2- and 1,3-propylene glycol, dipropylene glycol, decane-1,10-diol, glycerol, trimethylolpropane, butane-1,4-diol, hexane-1,6-diol, sucrose, alkylglycosides, for example methylglycoside and ethyleneglycoside, and glycol-glycosides, for example ethylene glycol-glycoside, propylene glycol-glycoside, glycerol glycoside and 1,2,6-hexanetriol glycoside, 1.3 Butylene Glycol Diacetate, Ethylene Glycol Diacetate, Glyceryl Monostearate, Monopropylene Gylcol, MPDiol Polypropylene Glycol, Propylene Glycol, Propylene Glycol Ether, diethylene glycol-monobutyl, dihydroxydiethyl ether, dihydroxypropane, dihydroxysuccinic acid, dimethyl carbinol, dipropylene glycol, octylene glycol, propanediol, propanetriol, propylene glycol, triethanol amine, triethylene glycol, trimethylene glycol, 2,4-pentadiol, polyglycerol polyricinoleate, poly(ethylene glycol) MW=200, 300, 400, 600, 1,000, 1,540, 1540 pharmaceutical grade, 3,400, 3,400 pharmaceutical grade, 7,500, 8,000 pharmaceutical grade, 10,000, 20,000, 35,000, poly(ethylene glycol) (200) adipate, poly(ethylene glycol)-bisphenol A diglycidylether adduct, poly(ethylene glycol) (200) adipate, poly(ethylene glycol)-bisphenol A diglycidylether adduct tetraacrylate, poly(ethylene glycol)(200, 400, 4,000)diacrylate, poly(ethylene glycol)(200, 400) diglycidyl ether, poly(ethylene glycol) (600) diglycidyl ether WPE=appr.400, poly(ethylene glycol) (600) diglycidyl ether WPE=appr.600, poly(ethylene glycol) (200, 400, 600, 1,000) dimethacrylate, poly(ethylene glycol) 400 dimethylether complexing agent, poly(ethylene glycol) (1,000, 2,000) dimethyl ether, poly(ethylene glycol)(90, 200, 400, 6000) distearate, poly(ethylene glycol)-P-toluene sulfonate, poly(ethylene glycol)(750) mono-methyl ether monocarboxymethyl ether, poly(ethylene glycol)(200, 400) monomethacrylate, poly(ethylene glycol) monomethyl ether MW 350,550, 750, 1900 AV, 5000), poly(ethylene glycol)(200, 400, 1000) mono-methylether monomethacrylate, poly(ethylene glycol) (1900, 5000) mono-methyl ether mono(succinimidyl succinate)ester, Diisopropanol amine, triisopropanol amine, triethanol amine, diethanol amine, dibutanol amine, and tributanol amine.

### PREPARATION OF RLPC PROCESS EXAMPLES

### EXAMPLE 1

Into a 500 ml glass-reaction kettle equipped with condenser, thermometer, and overhead rotor, 298.00 g (1.000 mmol) of 2-di(butylmethoxyamino)-4,6-diamino-1,3,5-triazine, 19.016 g (1.0555 mmols) of distilled water, 6.141 g (0.030 mmols) of 2-acrylamido-2-methylpropane-sulfonic acid were merged. The mixture was reacted at 64° C. under atmosphere (initial atmospheric pressure, 1 atm.) for 8 minutes, cooled to 28° C., and 17.000 g polyethylene glycol mw 300 (0.059 mmols) were mixed into the solution.

### EXAMPLE 2

Into a 500 mL glass-reaction kettle equipped with condenser, thermometer, and rotor, 298 g (1.00 mmols) of 2-di(butylmethoxyamino)-4,6-diamino-1,3,5-triazine, 20.130 g (1.117 mmols) of distilled water, polyoxyalkylated alkyl phosphate ester 5.3 g (0.034 mmols) were merged. The mixture was reacted at 71° C. under atmosphere (initial atmospheric pressure, 1.50 atm.) for 15 minutes, cooled to 27° C. and 17.000 g polyethylene glycol mw 300 (0.059 mmols) were mixed into the solution.

Other processes known in the chemical and engineering arts may be utilized to prepare the RLPC's of the present invention.

The cross-linking agents (RLPC) of this invention provide unique properties to polymer systems. Cross-linking agents provide chemical links or bonds between molecular chains of polymers that may effect the appearance, hardness, density, as well as the mechanical, thermal, electrical and chemical resistance properties of polymers. For example, mechanical properties such as tensile strength, compressive strength, flexural strength, shear strength, impact resistance and toughness, rigidity, creep and cold flow, fatigue, dimensional stability and durability may be altered by cross-linking a polymer. Thermal properties of a polymer such as the coefficient of expansion, thermal conductivity, specific heat, heat distortion temperature, heat resistance and flammability may also be altered by cross-linking. Electrical properties that may be effected include resistivity, dielectric strength, dielectric constant, power factor and arc resistance. With respect to chemical resistance, cross-linking of a polymer may increase its resistance to acids, bases, solvents, oils and fats.

The following Tables A-C exhibit properties of linear polymers enhanced with RLPC. Table A shows that the addition of RPLC to thermoplastic polyurethane increases its tensile strength, increases melting resistance as well as chemical resistance. Tables B and C show similar property enhancements with respect to Acrylics and Caprolactones, respectively.

TABLE A
Thermoplastic Polyurethane Properties

| | | | | Thermoplastic Polyurethane with | | |
|---|---|---|---|---|---|---|
| | Thermoplastic Polyurethane | | | RLPC | | |
| Huntsmen | CA116 ® | CA9068 ® | PS62 ® | CA116 ® | CA9068 ® | PS62 ® |
| Tensile Strength | 5900 psi | 3000 psi | 7000 psi | 6400 psi | 5400 psi | 7300 psi |
| Melt Flow Index | 80-150° C. | 90-130° C. | 140-174° C. | N/A | N/A | N/A |
| Methyl Ethyl | Soluble | Soluble | Soluble | N/A | N/A | N/A |
| Keytone | | | | | | |
| G-Butyrolactone | Soluble | Soluble | Soluble | N/A | N/A | N/A |
| Tetrahydrofuran | Soluble | Soluble | Soluble | Swell 30% | Swell 27% | Swell 30% |
| Xylol | Soluble | Soluble | Soluble | Swell 7% | Swell 5% | Swell 5% |
| DMF | Soluble | Soluble | Soluble | Swell 25% | Swell 28% | Swell 26% |
| Sulfuric Acid 12% | Softens | Softens | Softens | N/A | N/A | N/A |
| NaOH 18% | Softens | Softens | Softens | N/A | N/A | N/A |

TABLE B
Acrylic Properties

| | | | Acrylic Properties | |
|---|---|---|---|---|
| | Acrylic Properties | | with RLPC | |
| OMNOVA | DV571 ® | DV686 ® | DV571 ® | DV686 ® |
| Tensile Strength | 3480 psi | 2300 psi | 4150 psi | 4310 psi |
| Melt Flow Index | N/A | N/A | N/A | N/A |
| Methyl Ethyl | Swell 30% | Swell 31% | Swell 6% | Swell 6% |
| Ketone | | | | |
| G-Butyrolactone | Swell 15% | Swell 20% | N/A | N/A |
| Tetrahydrofuran | Swell 35% | Swell 58% | Swell 13% | Swell 14% |
| Xylol | Swell 14% | Swell 16% | N/A | N/A |
| DMF | Swell 50% | Swell 56% | Swell 16% | Swell 14% |
| Sulfuric Acid 14% | Insoluble | Insoluble | Insoluble | Insoluble |
| NaOH 14% | Insoluble | Insoluble | Insoluble | Insoluble |

TABLE C
Caprolactone Properties

| | | | Caprolactone Properties | |
|---|---|---|---|---|
| | Caprolactone Properties | | with RLPC | |
| Solvay | CAPA301 ® | CAPA304 ® | CAPA301 ® | CAPA304 ® |
| Tensile | N/A | N/A | 3100 psi | 2860 psi |
| Strength | | | | |
| Melt Flow | Liquid | Liquid | N/A | N/A |
| Index | 10° C. | 10° C. | | |
| Methyl Ethyl | Soluble | Soluble | Swell 8% | Swell 8% |
| Ketone | | | | |
| G- | N/A | N/A | N/A | N/A |
| Butyrolactone | | | | |
| Tetra- | Soluble | Soluble | Swell 22% | Swell 24% |
| hydrofuran | | | | |
| Xylol | Soluble | Soluble | N/A | N/A |
| DMF | Soluble | Soluble | Swell 26% | Swell 23% |
| Sulfuric Acid | Mixable | Mixable | N/A | N/A |
| 14% | | | | |
| NaOH 14% | Mixable | Mixable | N/A | N/A |

The following are examples of structures of RLPC's of the present invention which are substituted amino 1,3,5 triazine hydrates and which may be formed using the processes of the present invention:

### Structure 1 (Structure of a Substituted Amino Triazine Hydrate)

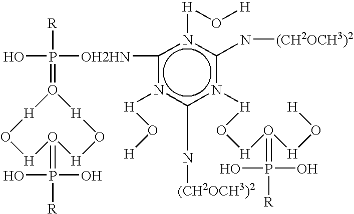

### Structure 2 (Structure of a Substituted Amino Triazine Hydrate)

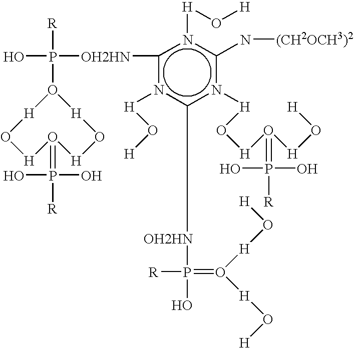

### Structure 3 (Structure of a Substituted Amino Triazine Hydrate)

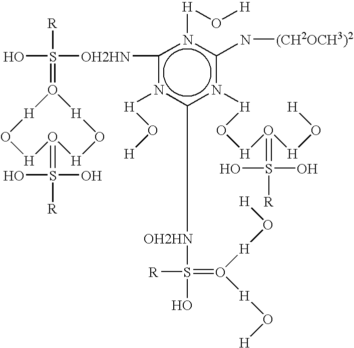

### Structure 4 (Structure of a Substituted Amino Trizaine Hydrate)

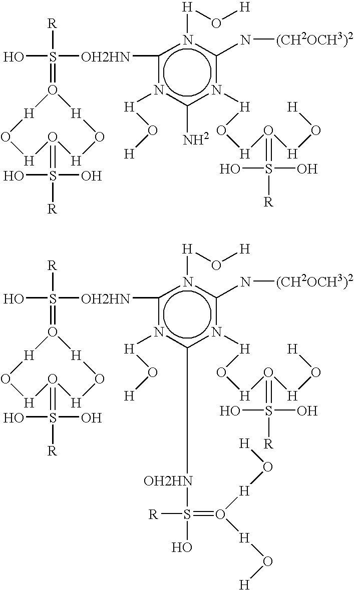

### Structure 5 (Structure of a Substituted Amino Triazine Hydrate)

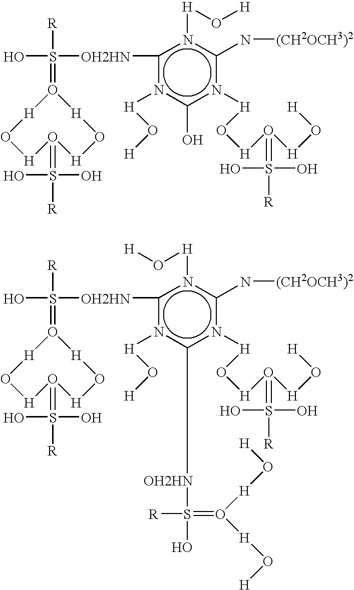

### Structure 6 (Structure of a Substituted Amino Triazine Hydrate)

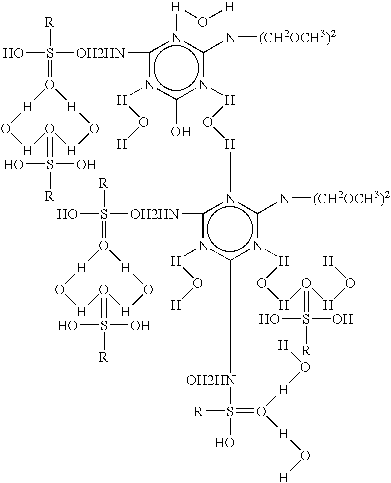

### Structure 7 (Structure of a Substituted Amino 1,3,5-Triazine Hydrate)

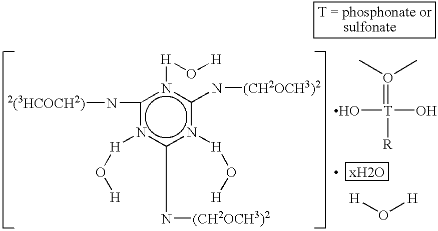

### Structure 8—Structure of a Melamine (Amino 1.3.5-Triazine) Hydrate

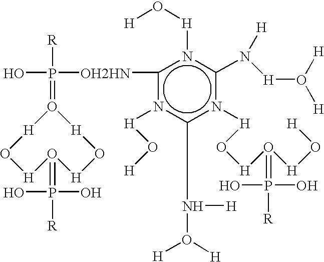

### Structure 9 (Structure of a Substituted Amino Triazine Phosphato Titanate Hydrate)

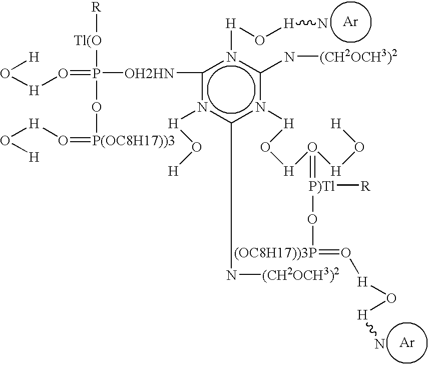

### Structure 10 (Structure of a Substituted Amino Triazine Sulfonyl Zirconate Hydrate)

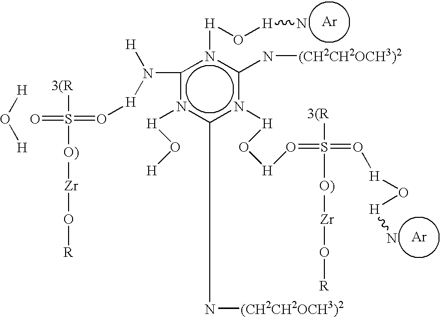

### EXAMPLES OF RLPC'S AND THEIR USES

The following are examples showing various compositions used to produce the Reactive Liquid Polymer Crosslinking Agent of the present invention, areas in which the RLPCs can be used, and examples of the RLPC in use.

1. RLPC Use with Epoxies

RLPC(1) Comprises:

| | | |
|---|---|---|
| T1a | 244.12 gm | 2-di(butylamino)-4,6-diamino-1,3,5-triazine |
| T1b | 12.21 gm | 2-acrylamido-2-methylpropane-sulfonic acid |
| T1c | 14.65 gm | Distilled Water |
| T1d | 52.89 gm | 1,3-propylene glycol |

Epoxies are compatible with many modifiers and which allows them to be formulated for a wide scope of applications. Many basic epoxies are unmodified, and these cure to a hard and brittle state, which restricts their utilization at low or cryogenic temperatures or for impact and peel loading, or where good stress-absorbing characteristics are needed. Most commercial epoxy resins are diepoxides made form bisphenol and epichlorohydrin, which are co-reacted to an epoxy equivalent weight of approximately 190 and a viscosity of 12,000 to 16,000 centipoise. Modification to the base resin usually consists of varying the epoxy equivalent weight or increasing the viscosity and pendant hydroxyl content. However, by using RLPC, a wide range of different epoxy resins can be manufactured with properties considerably different form the standard bisphoenol resins.

### EXAMPLE 1

A ratio by weight of 63.3-111.5 parts epoxy containing diols and triols, 6.1-36.0 parts by weight RLPC(1) gives flexible epoxy resins with high impact resistance and heat resistance. Using RLPC in combination with multifunctional ingredients yield resins with three or four epoxy groups, which results in more cross-links during cure and improves impact strength and reduces cost.

2. RLPC Use with Polymers

RLPC(2) Comprises:

| | | |
|---|---|---|
| T2a | 314.12 gm | 2,4-di(butylamino)-6-amino-1,3,5-triazine |
| T2b | 15.71 gm | neopentyl(diallyl)oxy,tri(dodecyl)benzene- |
| | | sulfonyltitanate |
| T2c | 18.85 gm | Distilled Water |
| T2d | 68.06 gm | ethylene glycol |

The development of useful structural plastics capable of long-term service at 500° F. has been slow. Conventional jet aircraft traveling at subsonic speeds generate skin temperatures of 350° F. or higher. New supersonic aircraft, both commercial and military, will generate skin temperatures of 450 to 500° F. as cruise speeds approach Mach 10. A reusable space shuttle requires structure capable of withstanding still higher service temperatures. Conventional plastics will not perform adequately in these environments. The best hope of retaining the advantages inherent in plastic structures while achieving the required performance at elevated temperature is the development of new high tech polymers based on PBI polymer chemistry's. For example, PBI polymers developed by Dr. Marvel in 1960 evoked immediate interest from the scientific community. Interest ran high in developing useful laminating resins and adhesives form these polymers. PBI is known for it is thermal stability; long-term service at 350° F. is outstanding. However, there are definite limitations to its use, for example long-term service in air at temperatures in excess of 400° F., where oxidative attack occurs, and may result in a loss of useful properties. Using RLPC of the present invention to modify PBI polymers results in outstanding thermal stability and increased oxidative stability, resulting in long-term service at 500° F.

### EXAMPLE 2

A ratio by weight of 180.6-302.5 parts PBI resin, 4.1-46.0 parts by weight RLPC (2), are combined in a Sigma Mixer, temperature keep below 40° C. until homogenous.

3. RLPC Use with Thermal Plastic Adhesives

RLPC(3) Comprises:

| | | |
|---|---|---|
| T3a | 378.00 g | 4,6-di(butylmethoxyamino)-2-amino-1,3,5-triazine |
| T3b | 18.9 g | polyoxyalkylated alkyl phosphate ester |
| T3c | 22.68 g | Distilled Water |
| T3d | 1.33 g | Polyethylene glycol 300 |

RLPC(4) Comprises:

| | | |
|---|---|---|
| T4a | 322.12 g | 2,4-di(2-hydroxyethylamino)-6-amino-1,3,5-triazine |
| T4b | 21.65 g | polyoxyalkylated alkyl sulfate ester |
| T4c | 23.19 g | Distilled Water |
| T4d | 7.2 g | Polypropylene glycol 300-4000 |

Hot-melt adhesives are defined as 100 percent nonvolatile thermoplastic materials which typically are solid at room temperature. They are melted, heated usually to 220° to 400° F., and applied in the molten state. On cooling, they solidify. The thermoplastic nature, melting when heated and solidifying when cooled, is inherent in hot-melt adhesives. Thermoplastic materials which are used in the molten state include polyethylene, ethylene-vinyl acetate, polyurethane and polycaprolactone. The major limitation of hot-melt adhesives is limited toughness at usable viscosities. The molecular weight and the concentration of the polymer determines the viscosity of the hot-melt adhesive. Raising the temperature lowers the viscosity of hot melts, however there is a point at which the hot melt degrades so rapidly its use becomes impractical. Using the RLPC of the present invention, a wide range of reactive hot-melts can be manufactured with properties considerably different from the standard hot-melts.

### EXAMPLE 3

A ratio by weight of 100.6-602.5 parts polycaprolactone resin, 8.1-120.0 parts by weight RLPC (3) are combined in a Sigma Mixer, temperature keep below 40° C. until homogenous. A ratio by weight of 80.6-402.5 parts acrylic resin, 1.6-80.0 parts by weight RLPC (4), are combined in a Sigma Mixer, temperature keep below 60° C. until homogenous.

4. RLPC Use with Polyesters

RLPC(5) Comprises

| | | |
|---|---|---|
| T5a | 350.12 g | 2,4-di(2-hydroxyisopropylamino)-6-amino-1,3,5- |
| | | triazine |
| T5b | 19.14 g | neopentyl(diallyl)oxy,tri(dioctyl)pyro- |
| | | phosphatotitanate |
| T5c | 28.01 g | Distilled Water |
| T5d | 75.86 g | butane-1,4-diol and hexane-1,6-diol |

The polyesters and alkyds comprise a very large family of resins derived form the reaction of organic acids and anhydrides with glycols. Polyester materials are used widely in automotive applications and in hulls of sea-going vessels. They often are used in sporting goods such as shuffleboard equipment, bowling balls, and billiard balls and in buttons Their outstanding properties include low cost, chemical resistance, low water absorption, and impact strength. They are not resistant to alkalies and are not high-temperature materials. The polyesters resins exhibit noticeable chemical resistance to high-temperature and alkalies by crosslinking with RLPC.

### EXAMPLE 4

| | | |
|---|---|---|
| Poly(ethylene Glycol)(5,000)monomethylether | 140.77-332.22 | grams |
| Paraplex ® G-62 (Polymerci Plasticizer) | 7.17-26.19 | grams |
| RLPC(5) | 1.13-24.00 | grams |

5. RLPC Use with Acrylic Resins

RLPC(6) Comprises

| | | |
|---|---|---|
| T6a | 190.00 g | 2-n-butylamino-4,6-diamino-1,3,5-triazine |
| T6b | 15.43 g | Phenylsulfonic acid |
| T6c | 16.25 g | Distilled Water |
| T6d | 8.35 g | diethylene glycol |

The acrylic plastics and resins include not only derivatives of acrylic esters but also the polymerizable products of acrylic and methacrylic acids, chlorides, nitrites, and amides. The acrylics find extensive application in outdoor signs employing internally lighted features, as well as innumerable architectural and secondary structural support members. Other uses include dome skylights, windshields on motor vehicles, and boats, windows on aircraft, and automotive taillight and stoplight lenses. The acrylic resins exhibit noticeable chemical resistance and weatherability by crosslinking with RLPC.

### EXAMPLE 5

Preparation of a crosslinkable Acrylic plastisol for windshields on motor vehicles and boats. The acrylics are modified in some instance with elastomers and other plastics and resins to produce alloys or multiphase systems with specific properties.

| | | |
|---|---|---|
| Rohamere ® 4944-F | 188.77-312.33 | grams |
| Paraplex ® G-62 (Polymerci Plasticizer) | 27.10-39.08 | grams |
| Triesyl phosphate (Monomeric Plasticizer) | 3.00-28.00 | grams |
| RLPC(6) | 2.23-21.16 | grams |

6. RLPC use with Alternative Coatings

RLPC(7) Comprises:

| | | |
|---|---|---|
| T7a | 174.12 g | 2-n-methoxyamino-4,6-diamino-1,3,5-triazine |
| T7b | 12.31 g | neopentyl(diallyl)oxy,tri(dodecyl)benzene- |
| | | sulfonylzirconate |
| T7c | 28.0 g | Distilled Water |
| T7d | 13.32 g | Sucrose, alkylglycosides |

Emissions of volatile organic compounds (VOC) and hazardous air pollutants (HAP) continue to be under pressure from the Environmental Protection Agency. This has resulted in a need for ultra-low VOC inks and coatings to comply with the federal Clean Air Act Amendments. Aqueous inks/coatings represent a major advance in the development of Inks and Coatings Industries. Polymer films and coatings are used in the electronics industry as insulating materials, fabric finishing, adhesive for fiber blocking, back coating furniture upholstery, foam-to-fabric, fabric lamination and protective coatings. Many aromatic polymers have superior mechanical strength, thermal stability, and solvent resistance. The polymer film patent portfolio includes the use of aromatic polymers as insulating layers in multi layer integrates circuit devices due to low dielectric constants, low moisture absorption, and good thermal stability. Polymer properties, such as thermal stability, low (VOC) and resistance to solvents can be further improved by crosslinking the polymers. Polymers prepared with RLPC agents develop excellent thermal stability and solvent resistance polymers.

### EXAMPLE 6

| | | |
|---|---|---|
| Acrygen ® | 90-382.13 | grams |
| RLPC(7) | 1.23-38.16 | grams |
| Distilled Water | .41-35.66 | grams |
| Thickener (Triton ®) | .20-14.32 | grams |

7. RLPC Use with Foams

RLPC(8) Comprises:

| | | |
|---|---|---|
| T8a | 126.12 g | 2,4,6-diamino-1,3,5-triazine |
| T8b | 9.39 g | phenylphosporic acid |
| T8c | 18.7 g | Distilled Water |
| T8d | 0 g | |

Urethane foam in laminate form, directly bonded to fabrics, plastics, and other flexible substrates, has been increasing in use. Thin gauges of foam, polyester, or polyether, can be heat laminated or adhesive bonded to a variety of fabrics. Urethane foams continue to make considerable gains in the automotive field including use in instrument panels, trim and crash pads, weather stripping and air filters. Open cell foams, both flexible polyether and polyether types, are used in homes and in industries, for example in aerospace applications. Commercial standards are increasing for foam improvements, for example, improved resistance to tear, abrasion, creep and flexural stresses is desired. Using RLPC with foams can achieve these qualities.

### EXAMPLE 7

RLPC foams may be used without undue loss of physical properties in temperatures ranging from below 0 to 120 degrees C. and have improved abrasion resistance.

Foam A

| | |
|---|---|
| Capped Polyoxypropylenediol | 79.00 Parts by weight |
| RLPC (8) | .5-14 Parts by weight |
| Polyoxypropylene tetrol, mol wt 450 | 10.00 Parts by weight |
| Monofluorotrichloromethane | 5.00 Parts by weight |
| 1,4-Butanediol | 11.00 Parts by weight |
| Triethylenediamine, 33% solution | 1.50 Parts by weight |
| Airthane ® PET NCO-9.10% | 44.00 Parts by weight |

Foam B

| | | |
|---|---|---|
| Huntsman ® PS62 | 100.00 | Parts by weight |
| Poly(Tetramethylene Ether Glycol) | 25.50-14 | Parts by weight |
| G-Butyrolactone | 25.00 | Parts by weight |
| RLPC (8) | 1.00-12.00 | Parts by weight |
| Celogen blowing agent | .30-5.0 | Parts by weight |

Foam C

| | | |
|---|---|---|
| Dispercoll ® UKA 8713 | 100.00 | Parts by weight |
| Stearic Acid | 5.00 | Parts by weight |
| Plastogen ® | 5.00 | Parts by weight |
| RLPC(8) | .50-16 | Parts by weight |
| Sodium bicarbonate | .4-16 | Parts by weight |

8. Mixing RLPC's

To develop systems that fully use all the positive contributions of RPLC crosslinkers, it is necessary to select the RLPC that best fits the requirements of the end-use application.

### EXAMPLE 8

RLPC's react readily with primary and secondary hydroxyl, carboxyl and amide-functional polymers and can produce powdered metal systems based on acrylic, polyester, alkyd or epoxy vehicle resins. These powdered metal systems can be used as conductive metallic adhesives, thermally conductive metallic polymer systems, and in casting metallic resins and adhesives. The crosslinking takes place at elevated temperatures (40-160° C.). By using mixtures of RLPC's it is possible to extend the window for cure down to forced-dry conditions as low as 24° C.

Metallic (A)

| | | |
|---|---|---|
| Polyethylene Glycol 300-8000 MW | 140.77-332.33 | grams |
| Caspol ® 1962 | 7.17-26.19 | grams |
| RLPC(2) | 1.13-24.00 | grams |
| RLPC(6) | 4.23-33.00 | grams |
| Aluminum powder .1μ-20μ | 12.04-525.00 | grams |

Metallic(B)

| | | |
|---|---|---|
| Caspol ® 5007 | 140.77-332.33 | grams |
| Propylene glycol mono-ricinoleate | 7.17-26.19 | grams |
| RLPC (3) | .83-24.00 | grams |
| RLPC (8) | 1.06-46.00 | grams |
| Silver Powder .5μ-23μ | 21.02-763.00 | grams |

Although various polymeric systems with which the substituted 1,3,5-triazine hydrates of the present invention may be beneficially utilized are discussed herein with respect to thermoplastics, resins, coatings, adhesives, epoxies, polyesters, foams, and the like, an exemplary list of polymers that may be modified with the polymer crosslinking agent of the present invention include: poly(acetal resin); polyacrolein; polyacrylamide MW 1,500, 50% sol. in water, MW 10,000 50% solution in water, MW 700,000-1,000,000, MW 5,000,000 1% aqueous solution, MW 18,000,000; poly(acrylamide-acrylic acid) MW 200,000 90:10 Na salt, MW >10,000,000 60:40 Na salt, MW 200,000, 30:70 Na salt; poly(acrylamide/2-methacryloxy-ethyltrimethylammonium bromide), poly(acrylamidoxime/divinylbenzene); poly(acrylic acid) MW 450,000, MW 1,000,000, MW 4,000,000, MW appr. 1800, MW 5,000, MW 50,000, MW 90,000; poly(acrylic acid, ammonium salt) MW 250,000; poly(acrylic acid, sodium salt) MW 2100, MW 3,000 (40% solids in water), MW 6000, MW apprx. 8,000 (40% solids in water), MW 20,000 (40% solids in water), MW 60,000 (35% solids), MW 140,000 (25% solids in water), MW 225, 000, (20% solids in water); poly(acrylic anhydride); poly(acrylonitrie-butadiene-styrene) powder; poly(acryloyl chloride) 25% sol in dioxane; poly(1-alanine) MW 3,000-4,000; poly(allylamine hydrochloride); poly(4-aminostyrene); poly(n-amyl methacrylate); polyaniline, emeraldine form (acid doped); polyaniline emeraldine form (undoped); polyaniline, water soluble; poly(gamma-benzyl-1-glutamate) MW 150,000-300,000; poly(benzyl methacrylate); poly(bisphenol a carbonate); poly(4-bromostyrene); polybutadiene MW 1,600, 2000, 3000, 400,000; polybutadiene, carboxyl terminated MW 1,350, 3000; polybutadiene, hydroxylterminated MW 2,000; poly(butadiene/acrylonitrile) 67:33; poly(butadiene/acrylonitrile)amine terminated; poly(butadiene/maleic anhydride) 25% soln. in acetone; poly(1,4-butanediol adipate); poly(n-butyl acrylate/2-methacryloxyethyltrimethylammonium bromide) 80:20, 20% soln. in water; poly(isobutyl acrylate); poly(n-butyl acrylate) 20% in toluene, 35% solids in toluene; poly(n-butyl acrylate/acrylic acid) 80:20 10% latex in water, 90:10 10% latex in water; 19911 poly(n-butyl acrylate/acrylate acid 50:50, 20% latex in water; 21058 poly(n-butyl acrylate/acrylic acid) 50:50, flakes; 02452 poly(iso-butyl methacrylate), fine powder; 07037 poly(tert-butyl methacrylate); polycaprolactam viscosity 2.4, MW 16,000; polycaprolactam viscosity 4.1 MW 35,000; polycaprolactone MW 10-20,000; polycaprolactone diol MW 1250, 2000; poly(2-chloro-,3-butadiene); poly(3-chloro-2-hydroxypropyl)methacryloxyethyl-dimethylammonium chloride); poly(4-chlorostyrene); poly(chlorostyrene) mixed isomers, linear; poly(chlorotrifluoroethylene); poly(decyl acrylate); poly(diallyl dimethyl ammonium chloride), dry powder, 20% solids; poly(2-dimethylaminoethyl methcrylate); poly(2,6-dimethyl-1,4-phenylene oxide); poly(dimethylsiloxane)methyl terminated MW 3,900, 5200, 17000; poly(dimethylsiloxane-b-ethylene oxide), methyl terminated MW 600; poly(dimethylsiloxane-b-ethylene oxide) MW 3000; poly ether ether ketone (peek); polyetherimide MW 30,000; poly(ethyl acrylate) MW 70,000; poly(ethyl acrylate/acrylic acid) 80:20, 10% latex in water; poly(ethyl acrylate/acrylic acid) 50:50, 20% soln. in ethanol; poly(ethyl acrylate/acrylic acid) 50:50, flakes; polyethylene, MW 700, 1000, 2000; polyethylene, MW 135,000 (reversed phase HPLC grade); poly(ethylene/acrylic acid) 92:8; polyethyl, chlorinated, 25% Cl; poly(ethylene glycol) MW 200, 300, 400, 600, 1000, 1540, 1540 pharmaceutical grade, 3400, 3400 pharmaceutical grade, 7500, 8000 pharmaceutical grade, 10,000, 20,000, 35,000; poly(ethylene glycol) (200) adipate; poly(ethylene glycol)-bisphenol a diglycidyl ether adduct; poly(ethylene glycol)-bisphenol a diglycidyl ether adduct tetraacrylate; poly(ethylene glycol) (200, 400, 4,000) diacrylate; poly(ethylene glycol) (200, 400) diglycidyl ether; poly(ethylene glycol) (600) diglycidyl ether WPE=appr. 400; poly(ethylene glycol) (600) diglycidyl ether WPE=appr. 600; poly(ethylene glycol) (200, 400, 600, 1,000) dimethacrylate; poly(ethylene glycol 400 dimethyl ether) complexing agent; poly(ethylene glycol)(1,000, 2,000) dimethyl ether; poly(ethylene glycol)(90, 200, 400, 6000) distearate; poly(ethylene glycol)-p-toluene sulfonate; poly(ethylene glycol)(750) mono-methyl ether monocarboxymethyl ether; poly(ethylene glycol) (200, 400) monomethacrylate; poly(ethylene glycol)monomethyl ether MW 350, 550, 750, 1900 AV, 5000; poly(ethylene glycol)(200, 400, 1000) mono-methylether monomethacrylate; poly(ethylene glycol)(1900, 5000) mono-methyl ether mono(succinimidyl succinate)ester; poly(ethylene-vinyl acetate) 60:40, 72:28, 82:18; poly(ethylene vinyl alcohol) co-polymer 14.7%, 25.4%, 56%, 68% vinyl alcohol; polyethyleneimine, branched mw 600, 1200, 1800, 10,000, 10,000 (30% in water) 70,000, 50-100,000; polyethylenimine, benzylated, powder; polyethyleneimine 6300 MW per methylated, permethobromide; polyethyleneimine, linear MW 20,000; poly(ethyl methacrylate), beads MW appr. 250,000; poly(2-ethyl-2-oxazoline) MW 5,000, 50,000; poly(ethyloxazoline)high MW 500,000; poly(furfuryl alcohol); poly(1-gylceryl monomethacrylate); poly(glycidyl methacrylate) 10% solution in MEK; poly(glycolic acid); poly(hexamethyleneadipamide) (nylon 6/6); poly(hexamethylenesebacamide) (nylone 6/10); poly(hexyl isocyanate); poly(4-hydroxybenzoic acid); poly((−)3-hydroxybutyric acid) Biodegradeable polymer MW 500,000; poly(2-hydroxyethyl methacrylate), powder MW 200.000; poly(2-hydroxyethyl methacrylate), 12% solids; poly(2-hydroxyethyl methacrylate/methacrylic acid), 90:10; poly(2-hydroxy-3-methacryloxy-propyltrimethylammonium chloride); poly(2-hydroxypropyl methacrylate); poly(p-iodostyrene); polyisobutylene MW 500, 800, 9300, liquid; poly(itaconic acid); poly(dl-lactic acid) MW 15-25000; poly(dl-lactic acid) i.v. 2.0-2.8; poly(1-lactic acid) MW 2,000, 50,000 i.v. 0.8-1.2, 100,000 i.v. 1.3-1.6, 200,000 i.v. 1.6-2.3, 300,000 i.v. 4.0-5.2, i.v.>7.0, KIT; poly(dl-lactide/glycoline) 90:10 i.v. 0.15-0.30; poly(dl-lactide/glycoline) 85/15 i.v. 0.50-0.65; poly(di-lactide/glycolide) 80:20; poly(dl-lactide/glycolide) 75/25 i.v. 0.50-0.65; poly(di-lactide/glycolide) 70:30; poly(dl-lactide/glycolide) 50/50 i.v. 0.50-0.65; poly(1-lactide acid-co-glycolide); poly(1-lactide/glycolide), 70:30; poly(lauryl acrylate) 20% in toluene; poly(lead methacrylate 2-ethylhex-anoate methyl methacrylate); poly(1-lysine hydrobromide) MW 40,000-60,000; poly(1-lysine hydrobromide) 0.1% aqueous, MW 60,000-120,000; polyy(1-lysine hydrobromide) powder MW 100,000-140,000; poly(maleic acid), 50% aqueous soln; poly(maleic anhydride); poly(maleic anhydride-1-octadecene); polymer sample kit (44 polymers 5 gr each); polymethacrylamide; poly(methacrylic acid) MW 100,000; poly(methacrylic acid), ammonium salt MW 15,000; poly(methacrylic acid), sodium salt MW 15,000; poly(methacryloxyethyltrimethyl-ammonium bromide); poly(methacryloxyethyltrimethyl-ammonium bromide) MW 200; poly(methacryloyl chloride); poly(methylene(polyphenyl)isocyanate); poly(methyl isopropenyl ketone); poly(MMA) MW 25000 beads 200 u; poly(MMA) MW 75000 beads 200 u; poly(MMA) MW 100,000 pellets; poly(MMA) MW 350,000 beads; poly(MMA/n-butyl methacrylate); poly(MMA/methacrylic acid, 75:25, 80:20, 90:10, 95:05; poly(4-methyl-1-pentene); poly(4-methylstyrene); poly(alpha-methylstyrene) MW 685; poly(alpha-methylstyrene-vinyl toluene); poly(4-methylstyrene/styrene), 90:10; poly(3-methylthiophene); poly(n-methylvinylamine); poly(octadecyl methacrylate); poly(3-octylthiophene); poly(oxyethylene)sorbitan monolaurate (TWEEN 20); poly(n-iso-propylacrylamide); poly(n-propyl acrylate) 25% in toluene; polypropylene, chromatographic; polypropylene, atactic; polypropylene, isotactic; poly(propylene glycol) MW 400, 1025, 4000; poly(propylene glycol) (n) diglycidyl ether n=200 WPE appr. 180; poly(propylene glycol) (n) diglyci-dyl ether n=400 WPE appr.530; poly(propylene glycol)(400)dimethacrylate; poly(propylene glycol)(300)monomethacrylate; polypropyene oxide-cyclocarbonate terminated; polypropyene oxide, epoxy end groups (2.1-2.3%) MW 4000; poly(iso-propyl methacrylate); polypyrrole; polystyrene MW 800-5000, 50,000, 125,000-250,000; polystrene, brominated; poly(styrene-acrylonitrile), 75:25; poly(styrene/butadiene) 85:15; poly(styrene/divinyl benzene) 8.0% DVB, 200-400 MESH; poly(styrene/divinyl benzene) 200-400 MESH, 2% DVB; poly(styrene-b-isoprene) MW 500,000-1,000,000; poly(styrene/maleic anhydride)1:1(molar) MW 1.600, 1.700, 1.900; poly(styrene/methyl-methacrylate) 70:30, MW 270.000; poly(styrenesulfonic acid) 30% in water; poly(styrene sulfonic acid), sodium salt MW 70,000, 500,000; poly(styrene sulfonate) MW 50,000; poly(styrenesulfonic acid/maleic acid)sodium salt,3:1,MW 20,000; poly(styrenesulfonyl fluoride); polysulfone resin MW 30,000; polysulfone, dihydroxyl terminated; poly(tetrafluoroethylene) teflon 3OB; poly(tetrafluoroethylene) teflon 7A; poly(tetrafluoroethylene) teflon 6; poly(tetramethylene ether glycol) MW 2900; poly(tetramethylene oxide)bis-4-aminobenzoate; poly(vinyl acetate) MW 90,000; poly(vinyl acetate) 40% hydrolyzed MW 72; poly(vinyl alcohol) MW 6000, MOL % hydrolyzed; poly(vinyl alcohol) MW 25000, 88 MOL % hydrolyzed; poly(vinyl alcohol) MW 25000, 98 MOL % hydrolyzed; poly(vinyl alcohol) MW 78000, 88 MOL % hydrolyzed; poly(vinyl alcohol) MW 78000, 98 mol % hydrolyzed; poly(vinyl alcohol) MW 78000, 99.7 MOL % hydrolyzed; poly(vinyl alcohol) MW 108,000, 99.7 MOL % hydrolyzed; poly(vinyl alcohol) MW 125,000, 88 MOL % hydrolyzed; poly(vinyl alcohol) MW 133,000, 99 MOL % hydrolyzed; poly(vinyl alcohol), n-methyl-4(4-formalstyryl)pyridinium 13.3% soln. in water; poly(vinylamine)hydrochloride; poly(vinyl butyral) MW 100,000-; poly(n-vinylcarbazole); poly(vinyl chloride) MW 110,000; poly(vinyl chloride/vinyl acetate/maleic acid) 86:13:1, MW 21.000; poly(vinyl cinnamate); poly(vinyl ferrocene); poly(vinyl formal) powder; poly(vinyl formal) 0.5% sol.; poly(vinylidene chloride/acrylonitrile) 80:20; poly(vinylidene fluoride) MW 60,000, 80,000, 120,000, 140,000, 350,000; poly(vinylidene fluoride7chlorotrifluoroethylene); poly(vinyl methyl ether/maleic anhydride)1:1(molar)Mn 41,000; poly(methyl vinyl ketone); poly(2-vinyl-1-methyl-pyridinium bromide) 20% soln. in water; poly(4-vinyl-1-methyl-pyridinium bromide) 20% soln. in water; poly(4-vinylphenol) MW 1,500-7,000, 9000-11,000, 22,000; poly(4-vinylphenol)brominated; poly(vinyl phosphoric acid), sodium salt; poly(vinyl phosphoric acid); poly(2-vinyl pyridine) 40,000 MW; poly(2-vinylpyridine) MW 200,000; poly(2-vinylpyridine) MW 300.000-400.000; poly(4-vinylpyridine) MW 50,000; poly(4-vinylpyridine) high MW, powder (MWT 150,000-200,000); poly(4-vinylpyridine divinylbenzene), beads; poly(2-vinylpyrrine-n-oxide); poly(4-vinylpyridine n-oxide) MW 200,000; poly(vinyl pyrrolidone) MW 2500, 10,000; poly(n-vinylpyrrolidone) MW 24,000 pharmaceutical grade; poly(vinyl pyrrolidone) MW 40,000, 40,000 pharmaceutical grade, MW 400,000, MW 1,000,000; poly(n-vinylpyrrolidone/2-dimethylaminoethyl methycrylate), dimethylsulfate QUAT.; poly(n-vinylpyrrolidone-dimethyl-aminoethylmethacrylate,QUAT.); poly(n-vinylpyrrolidone-vinyl acetate) 50% isopropanol solution; poly(n-vinylpyrrolidone/vinyl acetate) 50:50, 50% soln. in isopropanol; poly(n-vinylpyrroloidonevinyl acetate); poly(n-vinylpyrrolidone/vinyl acetate) 70:30, 50% soln. in isopropanol; poly(vinylsulfonic acid, sodium salt) MW 2,000; and like polymers.

As many changes are possible to the RLPC's and methods of this invention utilizing the teachings thereof, the descriptions above, and the accompanying drawing, should be interpreted in the illustrative and not in the limited sense.

That which is claimed is:

1. A method for preparing a reactive liquid polymer cross-linking agent comprising the steps of:
a) mixing a substituted 1,3,5-triazine having at least one amino or mono-substituted amino group, water and an acid alkyl sulfonate and/or an acid alkyl phosphonate, to form a reaction mixture;
b) hydrating said reaction mixture by heating the reaction mixture for a specified time period to a specified temperature, and at a specified pressure and specified pH; and
c) adding a solidifying modifier to said hydrated reaction mixture to form a substituted amino 1,3,5-triazine hydrate.

2. The method of claim 1, wherein said specified pressure is between approximately 1 and 100 psi.

3. The method of claim 1, wherein said specified pH of said reaction mixture is between approximately 2.3 and 8.7.

4. The method of claim 1, wherein said 1, 3, 5 triazine is reacted with an acid alkyl sulfonate in the presence of water to form said reaction mixture.

5. The method of claim 4, wherein said time period is between approximately 1 and 59 minutes and wherein said specified temperature is in the range between approximately 43-132° C.

6. The method of claim 1, wherein said 1, 3, 5 triazine is reacted with an acid alkyl phosphonate in the presence of water to form said reaction mixture.

7. The method of claim 6, wherein said time period is between approximately 12 and 90 minutes and wherein said specified temperature is in the range between approximately 60-152° C.

8. The method of claim 1, further comprising the step of cooling said reaction mixture to a temperature between approximately 22.2 and 92.5° C.

9. The method of claim 8, further comprising the step of placing said reaction mixture in a centrifuge to separate out any unreacted substituted 1,3,5-triazine.

10. The method of claim 9, further comprising the step of washing and recycling the unreacted substituted 1,3,5-triazine.

11. The method of claim 1, wherein said acid alkyl sulfonate and said acid alkyl phosphonate are selected from the group consisting of 2-acrylamido-amethylpropane-sulfonic acid, neopentyl(diallyl)oxy, tri(dodecyl)benzene-sulfonyltitanate, polyoxyalkylated alkyl phosphate ester, polyoxyalkylated alkyl sulfate ester, neopentyl(diallyl)oxy, tri(dioctyl)pyro-phosphatotitanate, phenylsulfonic acids, phenylsulfonic esters, neopentyl(diallyl)oxy, tri(dodecyl)benzence-sulfonylzincronate, phenylphosphoric acids, phenylphosphoric esters, neopentyl(diallyl)oxy, tri(dioctyl)pyro-phoshatozicronate, 4-(phenylsulfonyl-2-azetidinone, 2-(phenylsulfonyl)acetonitrile, di(dioctyl)pyrophosphate, oxoethylenetitanate, 2-(phenylsulfonyl)ethanol, 1-(phenylsulphonyl)pyrrole, 2-(phenylsulfonyl)tetrahydropyran, di(butyl,methyl)pyrophosphato, oxoethylene di(dioctyl)phosphitotitanate, 4-sulphonylidiphenol, di(dioctyl)pyrophosphatoethylenetitanate, di(butyl,methyl)pyrophosphato, ethylenetitanate, isopropyltri(dodecyl)benzenesulfonyl titanate, isopropyl(4-amino)benzenesulfonnyl di(dodecyl)benzenesulfonyl titanate, and isopropyl tri(dioctyl)pyrophosphatotitanate.

12. The method of claim 1, wherein said 1,3,5-triazine is selected from the group of substituted 1,3,5-triazines consisting of 2-n-methoxyamino-4,6-diamino-1,3,5-triazine; 2-di(methoxyamino)-4,6-diamino-1,3,5-triazine; 2,4-di(methoxyamino)-,6-amino-1,3,5-triazine; 2-n-butylmethoxyamino-4,6-diamino-1,3,5-triazine; 2-di(butylmethoxyamino)-4,6-diamino-1,3,5-triazine; 2,4-di(butylmethoxyamino)-6-amino-1,3,5-triazine; 2-n-butylamino-4,6-diamino-1,3,5-triazine; 2-di(butylamino)-4,6-diamino-1,3,5-triazine; 2,4-di(butylamino)-6-amino-1,3,5-triazine; 2-n-ethylmethoxyamino-4,6-diamino-1,3,5-triazine; 2,6-di(ethylmethoxyamino)-4-diamino-1,3,5-triazine; 2,6-di(butylmethoxyamino)-4-diamino-1,3,5-triazine; 2-di(2-hydroxyethylamino-4,6-diamino-1,3,5-triazines; 4-hydroxyethylamino-2,6-diamino-1,3,5-triazine; 2,4-di(2-hydroxyethylamino)-6-amino-1,3,5-triazine, 2,4-tris(2-hydroxyethylamino)-6-amino-1,3,5-triazine; 2-hydroxyisopropylamino-4,6-diamino-1,3,5-triazine; 1,3,5-triazine, 2,4-di(2-hydroxyisopropylamino)-6-amino-1,3,5-triazine; 2-isopropylmethoxyamino-4,6-diamino-1,3,5-triazine; 2,4-di(methoxyamino)-6-amino-1,3,5-triazine; 4,6-di(ethylmethoxyamino)-2-amino-1,3,5-triazine; 4,6-di(butylmethoxyamino)-2-amino-1,3,5-triazine; 2,-di(methoxyamino)-4,6-diamino-1,3,5-triazine; 2-ethylamino-4,6-diamino-1,3,5-triazine;2,4-bis(ethylamino)-6-amino-1,3,5-triazine; 2,4,6-tris(ethylamino)-1,3,5-triazine;2-diethylamino-4,6-bis(ethylamino)-1,3,5-triazine 8.2; 2-melamino-4-ethylamino-6-amino-1,3,5-triazine; 2-benzylamino-4,6-diamino-1,3,5-triazine; 2,4-bis(benzylamino)-6-amino-1,3,5-triazine; 2,4,6-tris(benzylamino)-1,3,5-triazine; 2-dibenzylamino-4,6-bis(benzylamino)-1,3,5-triazine; 2-n-butylamino-4,6-diamino-1,3,5-triazine; 2,4-bis(n-butylamino)-6-amino-1,3,5-triazine; 2,4,6-tris(n-butylamino)-1,3,5-triazine; 2-di-n-butylamino-4,6-bis(n-butylamino)-1,3,5-triazine 2,4-bis(di-n-butylamino)-6-n-butylamino-1,3,5-triazine; 2-benzylamino-4,6-diamino-1,3,5-triazine; 2,4-bis(benzylamino)-6-amino-1,3,5-triazine; 2,4,6-tris(benzylamino)-1,3,5-triazine; 2-n-butylamino-4,6-diamino-1,3,5-triazine; and 2,4-bis(n-butylamino)-6-amino-1,3,5-triazine.

13. The method of claim 1, wherein said solidifying modifier is from the group consisting of ethylene glycol, diethylene glycol, 1,2- and 1,3-propylene glycol, dipropylene glycol, decane-1,10-diol, glycerol, trimethylolpropane, butane-1,4-diol, hexane-1,6-diol, sucrose, alkylglycoside, methylglycoside, ethyleneglycoside, glycol-glycoside, ethylene glycol-glycoside, propylene glycol-glycoside, glycerol glycoside, 1,2,6-hexanetriol glycoside, 1.3 Butylene Glycol Diacetate, Ethylene Glycol Diacetate, Glyceryl Monostearate, Monopropylene Gylcol, MPDiol Polypropylene Glycol, Propylene Glycol, Propylene Glycol Ether, diethylene glycol-monobutyl, dihydroxydiethyl ether, dihydroxypropane, dihydroxysuccinic acid, dimethyl carbinol, dipropylene glycol, octylene glycol, propanediol, propanetriol, propylene glycol, triethanol amine, triethylene glycol, trimethylene glycol, 2,4-pentadiol, polyglycerol polyricinoleate, poly(ethylene glycol) MW=200, 300, 400, 600, 1,000, 1,540, 1540 pharmaceutical grade, 3,400, 3,400 pharmaceutical grade, 7,500, 8,000 pharmaceutical grade, 10,000, 20,000, 35,000, poly(ethylene glycol) (200) adipate, poly(ethylene glycol)-bisphenol A diglycidylether adduct, poly(ethylene glycol) (200) adipate, poly(ethylene glycol)-bisphenol A diglycidylether adduct tetraacrylate, poly(ethylene glycol)(200, 400, 4,000) diacrylate, poly(ethylene glycol)(200, 400) diglycidyl ether, poly(ethylene glycol) (600) diglycidyl ether WPE=appr.400, poly(ethylene glycol) (600) diglycidyl ether WPE=appr.600, poly(ethylene glycol) (200, 400, 600, 1,000) dimethacrylate, poly(ethylene glycol) 400 dimethylether complexing agent, poly(ethylene glycol) (1,000, 2,000) dimethyl ether, poly(ethylene glycol)(90, 200, 400, 6000) distearate, poly(ethylene glycol)-P-toluene sulfonate, poly(ethylene glycol)(750) mono-methyl ether monocarboxymethyl ether, poly(ethylene glycol)(200, 400) Monomethacrylate, poly(ethylene glycol) monomethyl ether MW (350,550, 750, 1900 AV, 5000), poly(ethylene glycol)(200, 400, 1000) mono-methylether monomethacrylate, poly(ethylene glycol) (1900, 5000) mono-methyl ether mono(succinimidyl succinate)ester, Diisopropanol amine, triisopropanol amine, triethanol amine, diethanol amine, dibutanol amine, and tributanol amine.

14. A reactive liquid polymer cross-linking agent produced using the process according to claim 1.

15. A method for preparing a reactive liquid polymer cross-linking agent comprising the steps of:
a) reacting a starting material comprising a substituted 1,3,5-triazine having at least one amino or mono-substituted amino group, in the presence of water, with an acid alkyl sulfonate and/or an acid alkyl phosphonate, to form a reaction mixture;
b) heating said reaction mixture for a specified time period to a specified temperature, and at a pressure in the range of approximately 1-100 psi and a pH in the range of approximately 2.3 and 8.7; and
c) adding a solidifying modifier to said reaction mixture to form a substituted amino 1,3,5-triazine hydrate, said solidifying modifier being a polyhydric alcohol.

16. The method of claim 15, wherein said 1, 3, 5 triazine is reacted with an acid alkyl sulfonate in the presence of water to form said reaction mixture.

17. The method of claim 16, wherein said specified time period is between approximately 1 and 59 minutes and wherein said specified temperature is in the range between approximately 43-132° C.

18. The method of claim 15, wherein said 1, 3, 5 triazine is reacted with an acid alkyl phosphonate in the presence of water to form said reaction mixture.

19. The method of claim 18, wherein said specified time period is between approximately 12 and 90 minutes and wherein said specified temperature is in the range between approximately 60-152° C.

20. The method of claim 15, wherein said acid alkyl sulfonate and said acid alkyl phosphonate are selected from the group of acid alkyl sulfonates and acid alkyl phosphonates consisting of 2-acrylamido-amethylpropane-sulfonic acid, neopentyl(diallyl)oxy, tri(dodecyl)benzene-sulfonyltitanate, polyoxyalkylated alkyl phosphate ester, polyoxyalkylated alkyl sulfate ester, neopentyl(diallyl)oxy, tri(dioctyl)pyro-phosphatotitanate, phenylsulfonic acids, phenylsulfonic esters, neopentyl(diallyl)oxy, tri(dodecyl)benzence-sulfonylzincronate, phenylphosphoric acids, phenylphosphoric esters, neopentyl(diallyl)oxy, tri(dioctyl)pyro-phoshatozicronate, 4-(phenylsulfonyl-2-azetidinone, 2-(phenylsulfonyl)acetonitrile, di(dioctyl)pyrophosphate, oxoethylenetitanate, 2-(phenylsulfonyl)ethanol, 1-(phenylsulphonyl)pyrrole, 2-(phenylsulfonyl)tetrahydropyran, di(butyl, methyl)pyrophosphato, oxoethylene di(dioctyl)phosphitotitanate, 4-sulphonylidiphenol, di(dioctyl)pyrophosphatoethylenetitanate, di(butyl,methyl)pyrophosphato, ethylenetitanate, isopropyltri(dodecyl) benzenesulfonyl titanate, isopropyl(4-amino) benzenesulfonnyl di(dodecyl)benzenesulfonyl titanate, and isopropyl tri(dioctyl)pyrophosphatotitanate.

21. The method of claim 15, wherein said 1,3,5-triazine is selected from the group of substituted 1,3,5-triazines consisting of 2-n-methoxyamino-4,6-diamino-1,3,5-triazine; 2-di(methoxyamino)-4,6-diamino-1,3,5-triazine; 2,4-di(methoxyamino)-,6-amino-1,3,5-triazine; 2-n-butylmethoxyamino-4,6-diamino-1,3,5-triazine; 2-di(butylmethoxyamino)-4,6-diamino-1,3,5-triazine; 2,4-di(butylmethoxyamino)-6-amino-1,3,5-triazine; 2-n-butylamino-4,6-diamino-1,3,5-triazine; 2-di(butylamino)-4,6-diamino-1,3,5-triazine; 2,4-di(butylamino)-6-amino-1,3,5-triazine; 2-n-ethylmethoxyamino-4,6-diamino-1,3,5-triazine; 2,6-di(ethylmethoxyamino)-4-diamino-1,3,5-triazine; 2,6-di(butylmethoxyamino)-4-diamino-1,3,5-triazine; 2-di(2-hydroxyethylamino-4,6-diamino-1,3,5-triazines; 4-hydroxyethylamino-2,6-diamino-1,3,5-triazine; 2,4-di(2-hydroxyethylamino)-6-amino-1,3,5-triazine, 2,4-tris(2-hydroxyethylamino)-6-amino-1,3,5-triazine; 2-hydroxyisopropylamino-4,6-diamino-1,3,5-triazine; 1,3,5-triazine, 2,4-di(2-hydroxyisopropylamino)-6-amino-1,3,5-triazine; 2-isopropylmethoxyamino-4,6-diamino-1,3,5-triazine; 2,4-di(methoxyamino)-6-amino-1,3,5-triazine; 4,6-di(ethylmethoxyamino)-2-amino-1,3,5-triazine; 4,6-di(butylmethoxyamino)-2-amino-1,3,5-triazine; 2,-di(methoxyamino)-4,6-diamino-1,3,5-triazine; 2-ethylamino-4,6-diamino-1,3,5-triazine;2,4-bis(ethylamino)-6-amino-1, 3,5-triazine; 2,4,6-tris(ethylamino)-1,3,5-triazine;2-diethylamino-4,6-bis(ethylamino)-1,3,5-triazine 8.2; 2-melamino-4-ethylamino-6-amino-1,3,5-triazine; 2-benzylamino-4,6-diamino-1,3,5-triazine; 2,4-bis(benzylamino)-6-amino-1,3,5-triazine; 2,4,6-tris(benzylamino)-1,3,5-triazine; 2-dibenzylamino-4,6-bis(benzylamino)-1,3,5-triazine; 2-n-butylamino-4,6-diamino-1,3,5-triazine; 2,4-bis(n-butylamino)-6-amino-1,3,5-triazine; 2,4,6-tris(n-butylamino)-1,3,5-triazine; 2-di-n-butylamino-4,6-bis(n-butylamino)-1,3,5-triazine 2,4-bis(di-n-butylamino)-6-n-butylamino-1,3,5-triazine; 2-benzylamino-4,6-diamino-1,3,5-triazine; 2,4-bis(benzylamino)-6-amino-1,3,5-triazine; 2,4,6-tris(benzylamino)-1,3,5-triazine; 2-n-butylamino-4,6-diamino-1,3,5-triazine; and 2,4-bis(n-butylamino)-6-amino-1,3,5-triazine.

22. The method of claim 15, wherein said solidifying modifier is selected from the group of solidifying modifiers consisting of ethylene glycol, diethylene glycol, 1,2- and 1,3-propylene glycol, dipropylene glycol, decane-1,10-diol, glycerol, trimethylolpropane, butane-1,4-diol, hexane-1,6-diol, sucrose, alkylglycoside, methylglycoside, ethyleneglycoside, glycol-glycoside, ethylene glycol-glycoside, propylene glycol-glycoside, glycerol glycoside, 1,2,6-hexanetriol glycoside, 1.3 Butylene Glycol Diacetate, Ethylene Glycol Diacetate, Glyceryl Monostearate, Monopropylene Gylcol, MPDiol Polypropylene Glycol, Propylene Glycol, Propylene Glycol Ether, diethylene glycol-monobutyl, dihydroxydiethyl ether, dihydroxypropane, dihydroxysuccinic acid, dimethyl carbinol, dipropylene glycol, octylene glycol, propanediol, propanetriol, propylene glycol, triethanol amine, triethylene glycol, trimethylene glycol, 2,4-pentadiol, polyglycerol polyricinoleate, poly(ethylene glycol) MW=200, 300, 400, 600, 1,000, 1,540, 1540 pharmaceutical grade, 3,400, 3,400 pharmaceutical grade, 7,500, 8,000 pharmaceutical grade, 10,000, 20,000, 35,000, poly(ethylene glycol) (200) adipate, poly(ethylene glycol)-bisphenol A diglycidylether adduct, poly(ethylene glycol) (200) adipate, poly(ethylene glycol)-bisphenol A diglycidylether adduct tetraacrylate, poly(ethylene glycol)(200, 400, 4,000) diacrylate, poly(ethylene glycol)(200, 400) diglycidyl ether, poly(ethylene glycol) (600) diglycidyl ether WPE=appr.400, poly(ethylene glycol) (600) diglycidyl ether WPE=appr.600, poly(ethylene glycol) (200, 400, 600, 1,000) dimethacrylate, poly(ethylene glycol) 400 dimethylether complexing agent, poly(ethylene glycol) (1,000, 2,000) dimethyl ether, poly(ethylene glycol)(90, 200, 400, 6000) distearate, poly(ethylene glycol)-P-toluene sulfonate, poly(ethylene glycol)(750) mono-methyl ether monocarboxymethyl ether, poly(ethylene glycol)(200, 400) Monomethacrylate, poly(ethylene glycol) monomethyl ether MW (350,550, 750, 1900 AV, 5000), poly(ethylene glycol)(200, 400, 1000) mono-methylether monomethacrylate, poly(ethylene glycol) (1900, 5000) mono-methyl ether mono(succinimidyl succinate)ester, Diisopropanol amine, triisopropanol amine, triethanol amine, diethanol amine, dibutanol amine, and tributanol amine.

23. The method of claim 15, wherein said reactive liquid polymer crosslinking agent is for use in the preparation of polymeric systems selected from the group of polymeric systems consisting of poly(acetal resin); polyacrolein; polyacrylamide MW 1,500, 50% sol. in water, MW 10,000 50% solution in water, MW 700,000-1,000,000, MW 5,000,000 1% aqueous solution, MW 18,000,000; poly(acrylamide-acrylic acid) MW 200,000 90:10 Na salt, MW >10,000,000 60:40 Na salt, MW 200,000, 30:70 Na salt; poly(acrylamide/2-methacryloxy-ethyltrimethylammonium bromide), poly(acrylamidoxime/divinylbenzene); poly(acrylic acid) MW 450,000, MW 1,000,000, MW 4,000,000, MW appr. 1800, MW 5,000, MW 50,000, MW 90,000; poly(acrylic acid, ammonium salt) MW 250,000; poly(acrylic acid, sodium salt) MW 2100, MW 3,000 (40% solids in water), MW 6000, MW apprx. 8,000 (40% solids in water), MW 20,000 (40% solids in water), MW 60,000 (35% solids), MW 140,000 (25% solids in water), MW 225, 000, (20% solids in water); poly(acrylic anhydride); poly(acrylonitrie-butadiene-styrene)powder; poly(acryloyl chloride) 25% sol in dioxane; poly(1-alanine) MW 3,000-4,000; poly(allylamine hydrochloride); poly(4-aminostyrene); poly(n-amyl methacrylate); polyaniline, emeraldine form (acid doped); polyaniline emeraldine form (undoped); polyaniline, water soluble; poly(gamma-benzyl-1-glutamate) MW 150,000-300,000; poly(benzyl methacrylate); poly(bisphenol a carbonate); poly(4-bromostyrene); polybutadiene MW 1,600, 2000, 3000, 400,000; polybutadiene, carboxyl terminated MW 1,350, 3000; polybutadiene, hydroxylterminated MW 2,000; poly(butadiene/acrylonitrile) 67:33; poly(butadiene/acrylonitrile)amine terminated; poly(butadiene/maleic anhydride) 25% soln. in acetone; poly(1,4-butanediol adipate); poly(n-butyl acrylate/2-methacryloxyethyltrimethylammonium bromide) 80:20, 20% soln. in water; poly(isobutyl acrylate); poly(n-butyl acrylate) 20% in toluene, 35% solids in toluene; poly(n-butyl acrylate/acrylic acid) 80:20 10% latex in water, 90:10 10% latex in water; 19911 poly(n-butyl acrylate/acrylate acid 50:50, 20% latex in water; 21058 poly(n-butyl acrylate/acrylic acid) 50:50, flakes; 02452 poly(iso-butyl methacrylate), fine powder; 07037 poly(tert-butyl methacrylate); polycaprolactam viscosity 2.4, MW 16,000; polycarpolactam viscosity 4.1 MW 35,000; polycaprolactone MW 10-20,000; polycaprolactone diol MW 1250, 2000; poly(2-chloro-,3-butadiene); poly(3-chloro-2-hydroxypropyl)methacryloxyethyl-dimethylammonium chloride); poly(4-chlorostyrene); poly(chlorostyrene) mixed isomers, linear; poly(chlorotrifluoroethylene); poly(decyl acrylate); poly(diallyl dimethyl ammonium chloride), dry powder, 20% solids; poly(2-dimethylaminoethyl methcrylate); poly(2,6-dimethyl-1,4-phenylene oxide); poly(dimethylsiloxane)methyl terminated MW 3,900, 5200, 17000; poly(dimethylsiloxane-b-ethylene oxide), methyl terminated MW 600; poly(dimethylsiloxane-b-ethylene oxide) MW 3000; poly ether ether ketone (peek); polyetherimide MW 30,000; poly(ethyl acrylate) MW 70,000; poly(ethyl acrylate/acrylic acid) 80:20, 10% latex in water; poly(ethyl acrylate/acrylic acid) 50:50, 20% soln. in ethanol; poly(ethyl acrylate/acrylic acid) 50:50, flakes; polyethylene, MW 700, 1000, 2000; polyethylene, MW 135,000 (reversed phase HPLC grade); poly(ethylene/acrylic acid) 92:8; polyethyl, chlorinated, 25% Cl; poly(ethylene glycol) MW 200, 300, 400, 600, 1000, 1540, 1540 pharmaceutical grade, 3400, 3400 pharmaceutical grade, 7500, 8000 pharmaceutical grade, 10,000, 20,000, 35,000; poly(ethylene glycol) (200) adipate; poly(ethylene glycol)-bisphenol a diglycidyl ether adduct; poly(ethylene glycol)-bisphenol a diglycidyl ether adduct tetraacrylate; poly(ethylene glycol) (200, 400, 4,000) diacrylate; poly(ethylene glycol) (200, 400) diglycidyl ether; poly(ethylene glycol) (600) diglycidyl ether WPE=appr. 400; poly(ethylene glycol) (600) diglycidyl ether WPE=appr. 600; poly(ethylene glycol) (200, 400, 600, 1,000) dimethacrylate; poly(ethylene glycol 400 dimethyl ether) complexing agent; poly(ethylene glycol)(1,000, 2,000) dimethyl ether; poly(ethylene glycol)(90, 200, 400, 6000) distearate; poly(ethylene glycol)-p-toluene sulfonate; poly(ethylene glycol)(750) mono-methyl ether monocarboxymethyl ether; poly(ethylene glycol) (200, 400) monomethacrylate; poly(ethylene glycol)monomethyl ether MW 350, 550, 750, 1900 AV, 5000; poly(ethylene glycol)(200, 400, 1000) mono-methylether monomethacrylate; poly(ethylene glycol)(1900, 5000) mono-methyl ether mono(succinimidyl succinate)ester; poly(ethylene-vinyl acetate) 60:40, 72:28, 82:18; poly(ethylene vinyl alcohol) co-polymer 14.7%, 25.4%, 56%, 68% vinyl alcohol; polyethyleneimine, branched mw 600, 1200, 1800, 10,000, 10,000 (30% in water) 70,000, 50-100,000; polyethylenimine, benzylated, powder; polyethyleneimine 6300 MW per methylated, permethobromide; polyethyleneimine, linear MW 20,000; poly(ethyl methacrylate), beads MW appr. 250,000; poly(2-ethyl-2-oxazoline) MW 5,000, 50,000; poly(ethyloxazoline)high MW 500,000; poly(furfuryl alcohol); poly(1-gylceryl monomethacrylate); poly(glycidyl methacrylate) 10% solution in MEK; poly(glycolic acid); poly(hexamethyleneadipamide) (nylon 6/6); poly(hexamethylenesebacamide) (nylone 6/10); poly(hexyl isocyanate); poly(4-hydroxybenzoic acid); poly((−)3-hydroxybutyric acid) Biodegradeable polymer MW 500,000; poly(2-hydroxyethyl methacrylate), powder MW 200.000; poly(2-hydroxyethyl methacrylate), 12% solids; poly(2-hydroxyethyl methacrylate/methacrylic acid), 90:10; poly(2-hydroxy-3-methacryloxy-propyltrimethylammonium chloride); poly(2-hydroxypropyl methacrylate); poly(p-iodostyrene); polyisobutylene MW 500, 800, 9300, liquid; poly(itaconic acid); poly(dl-lactic acid) MW 15-25000; poly(dl-lactic acid) i.v. 2.0-2.8; poly(1-lactic acid) MW 2,000, 50,000 i.v. 0.8-1.2, 100,000 i.v. 1.3-1.6, 200,000 i.v. 1.6-2.3, 300,000 i.v. 4.0-5.2, i.v.>7.0, KIT; poly(dl-lactide/glycoline) 90:10 i.v. 0.15-0.30; poly(dl-lactide/glycoline) 85/15 i.v. 0.50-0.65; poly(di-lactide/glycolide) 80:20; poly(dl-lactide/glycolide) 75/25 i.v. 0.50-0.65; poly(di-lactide/glycolide) 70:30; poly(dl-lactide/glycolide) 50/50 i.v. 0.50-0.65; poly(1-lactide acid-co-glycolide); poly(1-lactide/glycolide), 70:30; poly(lauryl acrylate) 20% in toluene; poly(lead methacrylate 2-ethylhex-anoate methyl methacrylate); poly(1-lysine hydrobromide) MW 40,000-60,000; poly(1-lysine hydrobromide) 0.1% aqueous, MW 60,000-120,000; poly(1-lysine hydrobromide) powder MW 100,000-140,000; poly(maleic acid), 50% aqueous soln; poly(maleic anhydride); poly(maleic anhydride-1-octadecene); polymer sample kit (44 polymers 5gr each); polymethacrylamide; poly(methacrylic acid) MW 100,000; poly(methacrylic acid), ammonium salt MW 15,000; poly(methacrylic acid), sodium salt MW 15,000; poly(methacryloxyethyltrimethyl-ammonium bromide); poly(methacryloxyethyltrimethyl-ammonium bromide) MW 200; poly(methacryloyl chloride); poly(methylene(polyphenyl)isocyanate); poly(methyl isopropenyl ketone); poly(MMA) MW 25000 beads 200u; poly(MMA) MW 75000 beads 200u; poly(MMA) MW 100,000 pellets; poly(MMA) MW 350,000 beads; poly(MMA/n-butyl methacrylate); poly(MMA/methacrylic acid, 75:25, 80:20, 90:10, 95:05; poly(4-methyl-1-pentene); poly(4-methylstyrene); poly(alpha-methylstyrene) MW 685; poly(alpha-methylstyrene-vinyl toluene); poly(4-methylstyrene/styrene), 90:10; poly(3-methylthiophene); poly(n-methylvinylamine); poly(octadecyl methacrylate); poly(3-octylthiophene); poly(oxyethylene)sorbitan monolaurate (TWEEN 20); poly(n-iso-propylacrylamide); poly(n-propyl acrylate) 25% in toluene; polypropylene, chromatographic; polypropylene, atactic; polypropylene, isotactic; poly(propylene glycol) MW 400, 1025, 4000; poly(propylene glycol) (n) diglycidyl ether n=200 WPE appr. 180; poly(propylene glycol) (n) diglyci-dyl ether n=400 WPE appr.530; poly(propylene glycol)(400)dimethacrylate; poly(propylene glycol)(300)monomethacrylate; polypropyene oxide-cyclocarbonate terminated; polypropyene oxide, epoxy end groups (2.1-2.3%) MW 4000; poly(iso-propyl methacrylate); polypyrrole; polystyrene MW 800-5000, 50,000, 125,000-250,000; polystrene, brominated; poly(styrene-acrylonitrile), 75:25; poly(styrene/butadiene) 85:15; poly(styrene/divinyl benzene) 8.0% DVB, 200-400 MESH; poly(styrene/divinyl benzene) 200-400 MESH, 2% DVB; poly(styrene-b-isoprene) MW 500,000-1,000,000; poly(styrene/maleic anhydride)1:1(molar) MW 1.600, 1.700, 1.900; poly(styrene/methyl-methacrylate) 70:30, MW 270.000; poly(styrenesulfonic acid) 30% in water; poly(styrene sulfonic acid), sodium salt MW 70,000, 500,000; poly(styrene sulfonate) MW 50,000; poly(styrenesulfonic acid/maleic acid)sodium salt,3:1,MW 20,000; poly(styrenesulfonyl fluoride); polysulfone resin MW 30,000; polysulfone, dihydroxyl terminated; poly(tetrafluoroethylene) teflon 30B; poly(tetrafluoroethylene) teflon 7A; poly(tetrafluoroethylene) teflon 6; poly(tetramethylene ether glycol) MW 2900; poly(tetramethylene oxide)bis-4-aminobenzoate; poly(vinyl acetate) MW 90,000; poly(vinyl acetate) 40% hydrolyzed MW 72; poly(vinyl alcohol) MW 6000, MOL % hydrolyzed; poly(vinyl alcohol) MW 25000, 88 MOL % hydrolyzed; poly(vinyl alcohol) MW 25000, 98 MOL % hydrolyzed; poly(vinyl alcohol) MW 78000, 88 MOL % hydrolyzed; poly(vinyl alcohol) MW 78000, 98 mol % hydrolyzed; poly(vinyl alcohol) MW 78000, 99.7 MOL % hydrolyzed; poly(vinyl alcohol) MW 108,000, 99.7 MOL % hydrolyzed; poly(vinyl alcohol) MW 125,000, 88 MOL % hydrolyzed; poly(vinyl alcohol) MW 133,000, 99 MOL % hydrolyzed; poly(vinyl alcohol), n-methyl-4(4-formalstyryl)pyridinium 13.3% soln. in water; poly(vinylamine)hydrochloride; poly(vinyl butyral) MW 100,000-; poly(n-vinylcarbazole); poly(vinyl chloride) MW 110,000; poly(vinyl chloride/vinyl acetate/maleic acid) 86:13:1, MW 21.000; poly(vinyl cinnamate); poly(vinyl ferrocene); poly(vinyl formal)powder; poly(vinyl formal) 0.5% sol.; poly(vinylidene chloride/acrylonitrile) 80:20; poly(vinylidene fluoride) MW 60,000, 80,000, 120,000, 140,000, 350,000; poly(vinylidene fluoride7chlorotrifluoroethylene); poly(vinyl methyl ether/maleic anhydride)1:1(molar)Mn 41,000; poly(methyl vinyl ketone); poly(2-vinyl-1-methyl-pyridinium bromide) 20% soln. in water; poly(4-vinyl-1-methyl-pyridinium bromide) 20% soln. in water; poly(4-vinylphenol) MW 1,500-7,000, 9000-11,000, 22,000; poly(4-vinylphenol) brominated; poly(vinyl phosphoric acid), sodium salt; poly(vinyl phosphoric acid); poly(2-vinyl pyridine) 40,000 MW; poly(2-vinylpyridine) MW 200,000; poly(2-vinylpyridine) MW 300.000-400.000; poly(4-vinylpyridine) MW 50,000; poly(4-vinylpyridine) high MW, powder (MWT 150,000-200,000); poly(4-vinylpyridine divinylbenzene), beads; poly(2-vinylpyrrine-n-oxide); poly(4-vinylpyridine n-oxide) MW 200,000; poly(vinyl pyrrolidone) MW 2500, 10,000; poly(n-vinylpyrrolidone) MW 24,000 pharmaceutical grade; poly(vinyl pyrrolidone) MW 40,000, 40,000 pharmaceutical grade, MW 400,000, MW 1,000,000; poly(n-vinylpyrrolidone/2-dimethylaminoethyl methycrylate), dimethylsulfate QUAT.; poly(n-vinylpyrrolidone-dimethyl-aminoethylmethacrylate,QUAT.); poly(n-vinylpyrrolidone-vinyl acetate) 50% isopropanol solution; poly(n-vinylpyrrolidone/vinyl acetate) 50:50, 50% soln. in isopropanol; poly(n-vinylpyrroloidonevinyl acetate); poly(n-vinylpyrrolidone/vinyl acetate) 70:30, 50% soln. in isopropanol; and poly(vinylsulfonic acid, sodium salt) MW 2,000.

24. The method of claim 15, including the steps of cooling said reaction mixture to a temperature between approximately 22.2 and 92.5° C., separating any unreacted substituted 1,3,5-triazine from said reaction mixture and washing and recycling the separated unreacted substituted 1,3,5-triazine.

25. A method for preparing a substituted amino 1,3,5-triazine hydrate comprising the steps of:
a) mixing a 1,3,5-triazine having at least one amino or mono-substituted amino group, water and an acid alkyl sulfonate and/or an acid alkyl phosphonate, to form a reaction mixture;
b) heating and hydrating said reaction mixture for approximately 1-90 minutes to a temperature of approximately 43-152° C., at a pressure in the range of approximately 1-100 psi and a pH in the range of approximately 2.3 and 8.7;
c) cooling said reaction mixture to a temperature between approximately 22.2 and 92.5° C;
d) separating out any unreacted substituted 1,3,5-triazine from the reaction mixture;
e) adding a solidifying modifier having a hydroxyl functional group to said hydrated reaction mixture to form said substituted amino 1,3,5-triazine hydrate; and
f) washing and recycling the separated out unreacted substituted 1,3,5-triazine.

26. The method of claim 25, wherein said 1,3,5-triazine is selected from the group of substituted 1,3,5-triazines consisting of 2-n-methoxyamino-4,6-diamino-1,3,5-triazine; 2-di(methoxyamino)-4,6-diamino-1,3,5-triazine; 2,4-di(methoxyamino)-,6-amino-1,3,5-triazine; 2-n-butylmethoxyamino-4,6-diamino-1,3,5-triazine; 2-di(butylmethoxyamino)-4,6-diamino-1,3,5-triazine; 2,4-di(butylmethoxyamino)-6-amino-1,3,5-triazine; 2-n-butylamino-4,6-diamino-1,3,5-triazine; 2-di(butylamino)-4,6-diamino-1,3,5-triazine; 2,4-di(butylamino)-6-amino-1,3,5-triazine; 2-n-ethylmethoxyamino-4,6-diamino-1,3,5-triazine; 2,6-di(ethylmethoxyamino)-4-diamino-1,3,5-triazine; 2,6-di(butylmethoxyamino)-4-diamino-1,3,5-triazine; 2-di(2-hydroxyethylamino-4,6-diamino-1,3,5-triazines; 4-hydroxyethylamino-2,6-diamino-1,3,5-triazine; 2,4-di(2-hydroxyethylamino)-6-amino-1,3,5-triazine, 2,4-tris(2-hydroxyethylamino)-6-amino-1,3,5-triazine; 2-hydroxyisopropylamino-4,6-diamino-1,3,5-triazine; 1,3,5-triazine, 2,4-di(2-hydroxyisopropylamino)-6-amino-1,3,5-triazine; 2-isopropylmethoxyamino-4,6-diamino-1,3,5-triazine; 2,4-di(methoxyamino)-6-amino-1,3,5-triazine; 4,6-di(ethylmethoxyamino)-2-amino-1,3,5-triazine; 4,6-di(butylmethoxyamino)-2-amino-1,3,5-triazine; 2,-di(methoxyamino)-4,6-diamino-1,3,5-triazine; 2-ethylamino-4,6-diamino-1,3,5-triazine;2,4-bis(ethylamino)-6-amino-1,3,5-triazine; 2,4,6-tris(ethylamino)-1,3,5-triazine;2-diethylamino-4,6-bis(ethylamino)-1,3,5-triazine 8.2; 2-melamino-4-ethylamino-6-amino-1,3,5-triazine; 2-benzylamino-4,6-diamino-1,3,5-triazine; 2,4-bis(benzylamino)-6-amino-1,3,5-triazine; 2,4,6-tris(benzylamino)-1,3,5-triazine; 2-dibenzylamino-4,6-bis(benzylamino)-1,3,5-triazine; 2-n-butylamino-4,6-diamino-1,3,5-triazine; 2,4-bis(n-butylamino)-6-amino-1,3,5-triazine; 2,4,6-tris(n-butylamino)-1,3,5-triazine; 2-di-n-butylamino-4,6-bis(n-butylamino)-1,3,5-triazine 2,4-bis(di-n-butylamino)-6-n-butylamino-1,3,5-triazine; 2-benzylamino-4,6-diamino-1,3,5-triazine; 2,4-bis(benzylamino)-6-amino-1,3,5-triazine; 2,4,6-tris(benzylamino)-1,3,5-triazine; 2-n-butylamino-4,6-diamino-1,3,5-triazine; and 2,4-bis(n-butylamino)-6-amino-1,3,5-triazine.

27. The method of claim 25, wherein said solidifying modifier is selected from the group of solidifying modifiers consisting of ethylene glycol, diethylene glycol, 1,2- and 1,3-propylene glycol, dipropylene glycol, decane-1,10-diol, glycerol, trimethylolpropane, butane-1,4-diol, hexane-1,6-diol, sucrose, alkylglycoside, methylglycoside, ethyleneglycoside, glycol-glycoside, ethylene glycol-glycoside, propylene glycol-glycoside, glycerol glycoside, 1,2,6-hexanetriol glycoside, 1.3 Butylene Glycol Diacetate, Ethylene Glycol Diacetate, Glyceryl Monostearate, Monopropylene Gylcol, MPDiol Polypropylene Glycol, Propylene Glycol, Propylene Glycol Ether, diethylene glycol-monobutyl, dihydroxydiethyl ether, dihydroxypropane, dihydroxysuccinic acid, dimethyl carbinol, dipropylene glycol, octylene glycol, propanediol, propanetriol, propylene glycol, triethanol amine, triethylene glycol, trimethylene glycol, 2,4-pentadiol, polyglycerol polyricinoleate, poly(ethylene glycol) MW=200, 300, 400, 600, 1,000, 1,540, 1540 pharmaceutical grade, 3,400, 3,400 pharmaceutical grade, 7,500, 8,000 pharmaceutical grade, 10,000, 20,000, 35,000, poly(ethylene glycol) (200) adipate, poly(ethylene glycol)-bisphenol A diglycidylether adduct, poly(ethylene glycol) (200) adipate, poly(ethylene glycol)-bisphenol A diglycidylether adduct tetraacrylate, poly(ethylene glycol)(200, 400, 4,000) diacrylate, poly(ethylene glycol)(200, 400) diglycidyl ether, poly(ethylene glycol) (600) diglycidyl ether WPE=appr.400, poly(ethylene glycol) (600) diglycidyl ether WPE=appr.600, poly(ethylene glycol) (200, 400, 600, 1,000) dimethacrylate, poly(ethylene glycol) 400 dimethylether complexing agent, poly(ethylene glycol) (1,000, 2,000) dimethyl ether, poly(ethylene glycol)(90, 200, 400, 6000) distearate, poly(ethylene glycol)-P-toluene sulfonate, poly(ethylene glycol)(750) mono-methyl ether monocarboxymethyl ether, poly(ethylene glycol)(200, 400) Monomethacrylate, poly(ethylene glycol)monomethyl ether MW (350,550, 750, 1900 AV, 5000), poly(ethylene glycol)(200, 400, 1000) mono-methylether monomethacrylate, poly(ethylene glycol) (1900, 5000) mono-methyl ether mono(succinimidyl succinate)ester, Diisopropanol amine, triisopropanol amine, triethanol amine, diethanol amine, dibutanol amine, and tributanol amine.

28. The method of claim 25, wherein said acid alkyl sulfonate and said acid alkyl phosphonate are selected from the group of acid alkyl sulfonates and acid alkyl phosphonates consisting of 2-acrylamido-amethylpropane-sulfonic acid, neopentyl(diallyl)oxy, tri(dodecyl)benzene-sulfonyltitanate, polyoxyalkylated alkyl phosphate ester, polyoxyalkylated alkyl sulfate ester, neopentyl(diallyl)oxy, tri(dioctyl)pyro-phosphatotitanate, phenylsulfonic acids, phenylsulfonic esters, neopentyl(diallyl)oxy, tri(dodecyl)benzence-sulfonylzincronate, phenylphosphoric acids, phenylphosphoric esters, neopentyl(diallyl)oxy, tri(dioctyl)pyro-phoshatozicronate, 4-(phenylsulfonyl-2-azetidinone, 2-(phenylsulfonyl)acetonitrile, di(dioctyl)pyrophosphate, oxoethylenetitanate, 2-(phenylsulfonyl)ethanol, 1-(phenylsulphonyl)pyrrole, 2-(phenylsulfonyl)tetrahydropyran, di(butyl, methyl)pyrophosphato, oxoethylene di(dioctyl)phosphitotitanate, 4-sulphonylidiphenol, di(dioctyl)pyrophosphatoethylenetitanate, di(butyl,methyl)pyrophosphato, ethylenetitanate, isopropyltri(dodecyl)benzenesulfonyl titanate, isopropyl(4-amino)benzenesulfonnyl di(dodecyl)benzenesulfonyl titanate, and isopropyl tri(dioctyl)pyrophosphatotitanate.
